(19) United States
(12) Patent Application Publication
(10) Pub. No.: US 2004/0262370 A1
(43) Pub. Date: Dec. 30, 2004

(54) High reliability solder joint with multilayer structure

(76) Inventor: Kazuaki Ano, Hayami-Gun (JP)

Correspondence Address: TEXAS INSTRUMENTS INCORPORATED, P O BOX 655474, M/S 3999, DALLAS, TX, 75265

(21) Appl. No.: 10/706,147

(22) Filed: Nov. 12, 2003

Related U.S. Application Data
(60) Provisional application No. 60/483,459, filed on Jun. 27, 2003.

(51) Int. Cl. B23K 31/00

(52) U.S. Cl. 228/180.21

(57) ABSTRACT

Disclosed are high reliability solder joints and methods for manufacturing the same. Methods are disclosed forming a solder joint (26) in an electronic assembly (10) having one or more copper connection sites (16) including steps for applying a nickel layer (22) with a carefully controlled thickness to the copper connection site (16), and applying a diffusion layer (24) to the thin nickel layer (22). Further steps are disclosed for positioning lead-free solder (18) adjacent to the diffusion layer (24), and for reflowing the solder (18) to form a highly reliable solder joint (26). Also disclosed is a solder joint (26) for use in a semiconductor apparatus (10) having at least one copper connection site (16). The solder joint (26) includes a thin intermetallic compound layer (28) bonded to the copper connection site (16) and lead-free solder (18) encapsulating the thin intermetallic compound layer (28).

### TECHNICAL FIELD

The invention relates to electronics and electronics manufacturing. More particularly, the invention relates to methods for forming solder joints in electronic components and semiconductor assemblies.

### BACKGROUND OF THE INVENTION

Connections among discrete semiconductor devices on printed circuit boards (PCBs) or other substrates are frequently made using solder joints. For example in a common semiconductor device assembly process, solder nodules or “balls” having spherical, near-spherical, or other shapes are positioned at prepared metallized locations, or connection sites, on a workpiece such as a PCB or other semiconductor device assembly. The workpiece is then heated, typically to about 220° C. or more, to reflow the solder balls. Upon cooling, the solder balls bond with the metallized locations. A wire or semiconductor package or circuit board having a corresponding pattern of metallized connection sites may be aligned with the workpiece and bonded to it by controlled heating.

Numerous techniques have been developed for aligning, positioning, retaining, and attaching solder on connection sites on a workpiece. Despite the various approaches, problems still arise in the formation of a robust solder joint between the solder and the metallized connection site. Electronic devices and assemblies, including both components and PCBs, are increasingly required to withstand mechanical shocks; for example, drop tests are used to subject semiconductor assemblies to being dropped from a known height onto a hard surface. In attempts to improve drop test performance, solder joints are sometimes formed on bare copper connection sites. The use of solder directly on bare copper connection sites avoids the formation of nickel-tin intermetallic compounds that might otherwise result from nickel-plated connection sites known in the arts. Such efforts are beset with further problems, however. Since copper is easily oxidized, additional manufacturing steps are required to preserve or clean the exposed copper connection sites, resulting in increased costs. Another problem with solder joints formed directly on copper connection sites is the unchecked formation of copper-tin intermetallic compounds over time. This can result in the weakening of the solder joint, and ultimately in its failure under mechanical stress. Due to these and other problems, solder joints resistant to mechanical stresses, and cost-effective methods for forming the same, would be useful and advantageous in the arts.

### SUMMARY OF THE INVENTION

In carrying out the principles of the present invention, in accordance with preferred embodiments thereof, a thin layer of nickel is provided at the copper connection site of a semiconductor device to facilitate the formation of intermetallic compounds including copper-tin in a reliable solder joint upon reflow using common manufacturing processes.

According to one aspect of the invention, methods for forming a solder joint in an electronic assembly having one or more copper connection sites include steps of applying a thin nickel layer to a copper connection site and applying a diffusion layer to the thin nickel layer. Further steps provide for the positioning of lead-free solder adjacent to the diffusion layer, and for reflowing the solder for forming a solder joint at the copper connection site.

According to another aspect of the invention, methods for forming a solder joint in an electronic assembly having at least one copper connection sites include steps for applying a thin nickel layer to a copper connection up to a thickness of approximately 0.28 microns.

According to an aspect of the invention, preferred methods are disclosed in which steps for reflowing solder on a prepared copper connection site include the formation of a copper-tin intermetallic compound bond between the copper connection site and the solder.

According to yet another aspect of the invention, preferred methods are disclosed in which steps for reflowing solder on a prepared copper connection site include the formation of a copper-nickel-tin intermetallic compound bond between the copper connection site and the solder.

According to still another aspect of the invention, a solder joint for a semiconductor apparatus assembly having at least one copper connection site is provided. The solder joint includes a thin intermetallic compound layer, the thin intermetallic compound layer having copper-tin bonded to the copper connection site. The solder joint also has a thin nickel layer bonded to the intermetallic compound layer and lead-free solder encapsulating the thin nickel layer and the intermetallic compound layer.

According to a further aspect of the invention, a preferred embodiment is disclosed in which a solder joint according to invention has a thin intermetallic compound layer, which includes copper-nickel-tin.

According to another further aspect of the invention, a preferred embodiment includes an intermetallic compound layer having an undulating structure.

The invention provides technical advantages over the prior art including but not limited to improvements in strength, range of operating conditions, and reliability. Advantages in cost are also achieved. These and other features, advantages, and benefits of the present invention can be understood upon careful consideration of the detailed description of representative embodiments of the invention in connection with the accompanying drawings.

### BRIEF DESCRIPTION OF THE DRAWINGS

The present invention will be more clearly understood from consideration of the following detailed description and drawings in which:

FIG. 1A is a cut-away partial side view illustrating an example of a preferred embodiment of a solder joint and steps in a method of manufacturing the same according to the invention;

FIG. 1B is a cut-away partial side view further illustrating an example of a preferred embodiment of a solder joint and method steps according to the invention;

FIG. 1C is a cut-away partial side view further illustrating an example of a preferred embodiment of a solder joint and method steps according to the invention;

FIG. 2 is a graphical representation of an element line profile analysis of an exemplary embodiment of a solder joint according to the invention;

FIG. 3 is a graphical representation of an element line profile analysis of an exemplary embodiment of a solder joint according to the invention;

FIG. 4 is a partial cross-sectional view of a solder joint according to an example of a preferred embodiment of the invention; and

FIG. 5 is a graphical representation of an example of drop test results obtained using preferred embodiments of the invention.

References in the detailed description correspond to the references in the figures unless otherwise noted. Descriptive and directional terms used in the written description such as first, second, left, right, top, bottom, and so forth refer to the drawings themselves as laid out on the paper and not to physical limitations of the invention unless specifically noted. The drawings are not to scale, and some features of embodiments shown and discussed are simplified or amplified for illustrating the principles, features, and advantages of the invention.

### DETAILED DESCRIPTION OF PREFERRED EMBODIMENTS

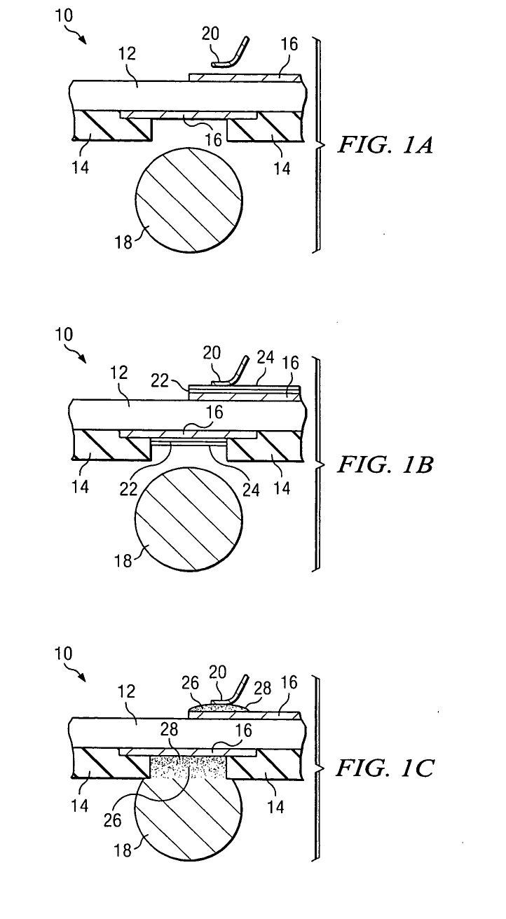

In general, the preferred embodiments of the invention provide a reliable solder joint and methods of manufacturing the same. Sequential FIGS. 1A through 1C illustrate an example of the steps and apparatus of a preferred embodiment of the invention. First referring primarily to FIG. 1A, a portion of a semiconductor device 10 known to artisans is shown in cross-section. The device 10 has a substrate 12 and dielectric material 14. The device 10 has copper connection sites 16 to facilitate the electrical connection of the device 10 to other connection sites not shown, using for example a solder ball 18 or wire 20 connection. It should be understood that the device 10 shown is intended to represent a typical semiconductor device having one or more copper connection site 16, and not to limit the scope of the invention. Examples of devices with which the invention may be used include but are not limited to BGAs, PCBs, CSPs, flip-chips, leadless or leaded components, QFPs and QFNs.

FIG. 1B shows a portion of a semiconductor device 10 in cross-section from the same vantage point as FIG. 1A. Again, the device 10 has a substrate 12 and dielectric material 14 and one or more copper connection site 16 typical in the arts. A thin tin layer 22 is shown applied to each of the copper connection sites 16. A diffusion layer 24, of gold or palladium is preferably applied to the thin tin layer 22. Solder 18, preferably lead-free solder with a relatively high proportion of tin and relatively low proportions of silver and copper, is positioned at the connection site 16 preparatory to heating. Various positioning techniques are known in the arts and may be used. Flux materials are also widely known in the arts and may be interposed between the solder 18 and the prepared connection site 16 without departure from the invention.

Now referring primarily to FIG. 1C, upon reflow of the solder 18 and subsequent cooling, a solder joint 26 is formed. The solder joint 26 mechanically and electrically connects the connection site 16 with the solder 18. Of course, additional wires or corresponding device connection sites (not shown) may be aligned with the solder joints 26 and connected as well. The solder joint 26 includes a thin intermetallic compound layer 28 forming a bond between the solder 18 and the copper connection site 16. Preferably the thin intermetallic compound layer 28 is primarily copper-tin, or copper-nickel-tin.

It has been determined that it is preferable to form the nickel layer 22 shown in FIG. 1B within a particular range of thicknesses in order to promote the formation of a strong and durable intermetallic compound layer 28 (FIG. 1C). Preferably, the nickel layer 22 is thick enough to provide enough material to facilitate the formation of sufficient copper-tin and/or copper-tin-nickel intermetallic compounds 28 to provide a strong bond, and to retard further growth of copper-tin intermetallic compound subsequent to reflow. On the other hand, it is also preferable to keep the nickel layer 22 thin enough to avoid the formation of excessive nickel-tin intermetallic compound, which might detract from the strength of the solder joint 26 due to its brittleness. Additionally, it is believed that an excessively thick nickel layer would act as a diffusion barrier to the tin, which would prevent the formation of beneficial copper-tin IMCs. It has been determined that a nickel layer 22 thickness in excess of about 0.28 microns provides excessive nickel, which may diffuse through the intermetallic compounds formed in the solder joint 26 causing the excessive formation of nickel-tin and resulting in a weak bond. Thus, it is presently preferred to maintain the thickness of the nickel layer 22 within the range of about 0.05 microns to about 0.28 microns, although it is believed that thinner nickel layers may possibly be used. The thickness of the nickel layer 22 may be varied within the specified range without departure from the principles of the invention.

The diffusion layer 24 is preferably diffused into the solder joint 26 upon reflow to promote bonding. To facilitate diffusion and promote bonding, the diffusion layer is preferably made with palladium or gold approximately 0.1 microns to 0.3 microns in thickness.

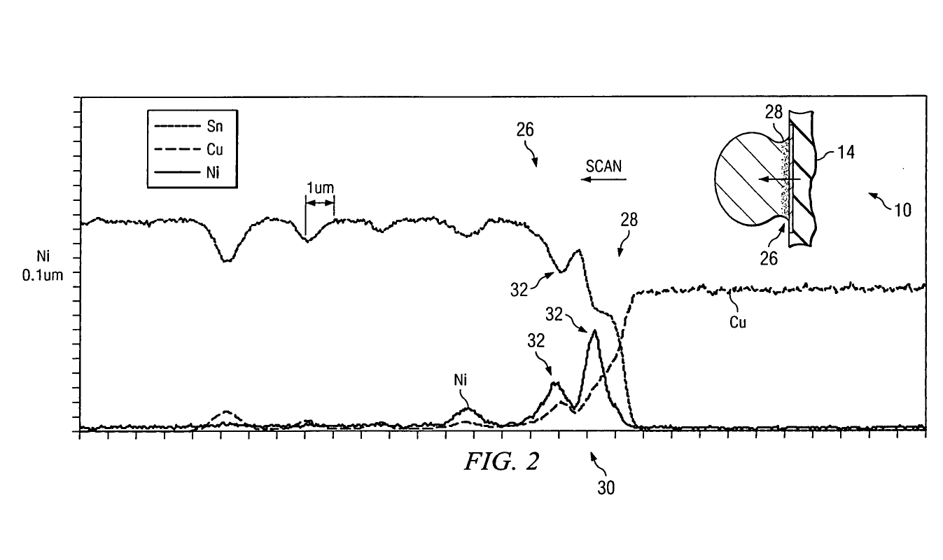

FIG. 2 provides an Element Line Profile Analysis 30 of an exemplary embodiment of a solder joint 26 made according to the invention. The example solder joint 26 shown was made according to the invention as described with reference to FIGS. 1A through 1C using a thin nickel layer about 0.1 microns in thickness. The Element Line Profile Analysis 30 was made from the package 14 side of the device 10. It can be seen that the elements tin Sn, nickel Ni, and copper Cu are each represented by the traces marked. The solder joint 26 was scanned for a distance of about 30 microns. The thin intermetallic compound layer 28 can be seen by the area of convergence of the element traces, Sn, Ni, Cu. The relatively high proportions of tin Sn and copper Cu, and relatively low level of nickel Ni can be noted. It should also be appreciated that the traces shown Sn, Ni, Cu include undulations, as shown for example by reference numeral 32, indicating undulations in the actual intermetallic compound layers 28, which are believed to increase the strength of the solder joint 26.

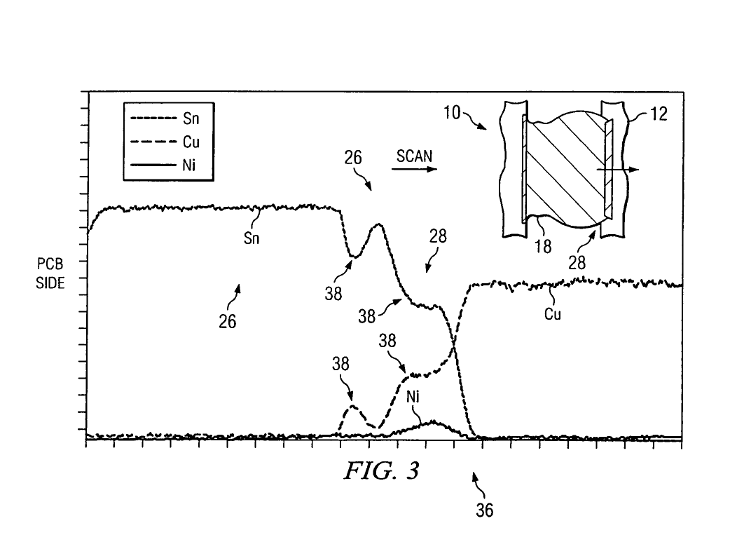

FIG. 3 shows an Element Line Profile Analysis 36 of another example of a preferred embodiment of a solder joint 26 made according to the invention. The example solder joint 26 shown was made according to the invention as described with reference to FIGS. 1A through 1C using a thin nickel layer about 0.1 microns in thickness. The Element Line Profile Analysis 32 of FIG. 3 differs in orientation from that of FIG. 2 in that it was made from the PCB side 12 of the device 10. Again, it can be seen that the elements tin Sn, nickel Ni, and copper Cu are each represented by the traces marked. The thin intermetallic compound layer 28 can be seen by the area of convergence of the element traces, Sn, Ni, Cu. The relatively high proportions of tin Sn and copper Cu, and the particularly low level of nickel Ni can again be noted. The traces Sn, Ni, Cu include undulations, as shown for example by reference numeral 38, indicating undulations in the actual thin intermetallic compound layers 28, which are believed to increase the strength of the solder joint 26. Comparison of FIG. 2 with FIG. 3 shows that the practice of the invention is not limited to a particular type of copper connection site.

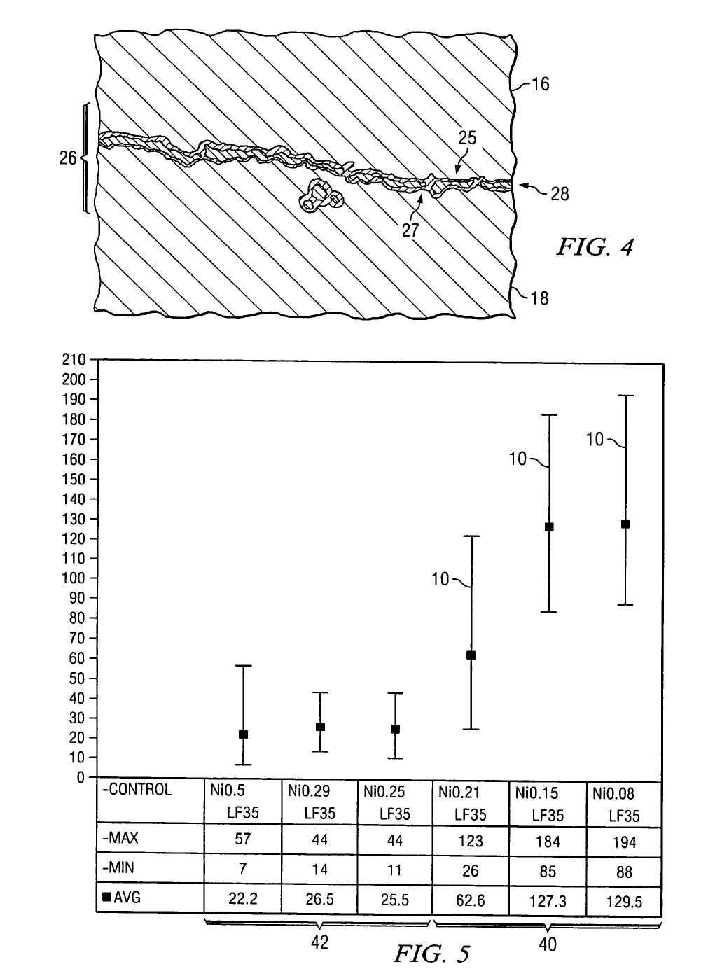

FIG. 4 provides a close-up cross sectional view of a portion of a solder joint 26 made in accordance with an embodiment of the invention. The intermetallic layers 28 can be seen to be dispersed throughout the solder joint 26. Preferably, the intermetallic layers include various combinations of copper, tin, and nickel to form relatively greater quantities of copper-tin 25 and lesser quantities of nickel-tin 27.

FIG. 5 is a graphical representation of drop test results. Devices including solder joints made in accordance with the invention as shown and described herein were dropped from a height of 1 m onto a hard surface at an acceleration of 1.5 kG. These parameters were intended to induce mechanical shocks similar to those of an electronic assembly intended for use in a portable application. The test parameters, devices using representative embodiments of the invention, and other devices depicted provide examples for demonstrating the implementation of the presently preferred embodiments of the invention and are not intended to be restrictive or to imply that variations within the bounds of the description and claims herein may not be made. The y-axis represents the number of drops performed as described. The x-axis represents the various thicknesses of nickel layers used in the devices tested. Devices 10 using a thin nickel Ni layer 22 in the formation of solder joints 26 according to the invention are shown 40 to range from approximately 0.05 microns to approximately 0.28 microns. For the purpose of comparison, devices using thicker nickel layers (not part of the invention) are also shown 42. It can be seen that the devices 10 made according to the invention were better able to withstand drops, consistently providing averages above the selected demonstration benchmark of 40 drops.

Thus, the invention includes methods and apparatus providing mechanically reliable and durable solder joints. While the invention has been described with reference to certain illustrative embodiments, the methods and apparatus described are not intended to be construed in a limiting sense. It should be appreciated that the invention may be used with various semiconductor assemblies and package configurations, including for example, PCB, BGA, CSP, flip-chip, leadless or leaded components, QFP and QFN. Various modifications and combinations of the illustrative embodiments as well as other advantages and embodiments of the invention will be apparent to persons skilled in the arts upon reference to the description and claims.

1. A method for forming a solder joint in an electronic assembly having one or more copper connection sites, the method comprising the steps of:
applying a thin nickel layer to at least one copper connection site;
applying a diffusion layer to the thin nickel layer;
positioning lead-free solder adjacent to the diffusion layer;
reflowing the solder thereby forming a solder joint at the copper connection site.

2. A method according to claim 1 wherein the thin nickel layer is applied to a thickness of greater than about 0.05 microns.

3. A method according to claim 1 wherein the thin nickel layer is applied to a thickness of less than about 0.05 microns.

4. A method according to claim 1 wherein the thin nickel layer is applied to a thickness of less than about 0.28 microns.

5. A method according to claim 1 wherein the thin nickel layer is applied to a thickness within the range of approximately 0.05 microns to approximately 0.28 microns.

6. A method according to claim 1 wherein the diffusion layer is applied to a thickness of greater than about 0.1 microns.

7. A method according to claim 1 wherein the diffusion layer is applied to a thickness of less than about 0.3 microns.

8. A method according to claim 1 wherein the diffusion layer is applied to a thickness within the range of approximately 0.1 microns to approximately 0.3 microns.

9. A method according to claim 1 wherein the diffusion layer comprises palladium.

10. A method according to claim 1 wherein the diffusion layer comprises gold.

11. A method according to claim 1 wherein the step of reflowing the solder further comprises the formation of a copper-tin intermetallic compound bond between the copper connection site and the solder.

12. A method according to claim 1 wherein the step of reflowing the solder further comprises the formation of a copper-nickel-tin intermetallic compound bond between the copper connection site and the solder.

13. A solder joint for a semiconductor apparatus assembly, wherein the assembly has at least one copper connection site, the solder joint comprising:
a thin nickel layer on at least one copper connection site;
a diffusion layer on the thin nickel layer; and
lead-free solder joined to the copper connection site.

14. A solder joint according to claim 13 wherein the solder joint further comprises a copper-tin intermetallic compound.

15. A solder joint according to claim 13 wherein the solder joint further comprises a copper-tin-nickel intermetallic compound.

16. A solder joint according to claim 13 wherein the thin nickel layer comprises nickel having a thickness of greater than about 0.05 microns.

17. A solder joint according to claim 13 wherein the thin nickel layer comprises nickel having a thickness of less than about 0.28 microns.

18. A solder joint according to claim 13 wherein the thin nickel layer comprises nickel having a thickness within a range of between approximately 0.05 microns and approximately 0.28 microns.

19. A solder joint according to claim 13 wherein the diffusion has a thickness of greater than about 0.1 microns.

20. A solder joint according to claim 13 wherein the diffusion layer has a thickness of less than about 0.3 microns.

21. A solder joint according to claim 13 wherein the diffusion layer has a thickness within a range of between approximately 0.1 microns and approximately 0.3 microns.

22. A solder joint according to claim 13 wherein the diffusion layer comprises palladium.

23. A method according to claim 13 wherein the diffusion layer comprises gold.

24. A solder joint for a semiconductor apparatus assembly, wherein the assembly has at least one copper connection site, the solder joint comprising:
a thin intermetallic compound layer comprising copper-tin bonded to the copper connection site;
a thin nickel layer bonded to the thin intermetallic compound layer;
lead-free solder encapsulating the thin nickel layer and the intermetallic compound layer forming a solder joint.

25. A solder joint according to claim 24 wherein the thin intermetallic compound layer further comprises copper-nickel-tin.

26. A solder joint according to claim 24 wherein the lead-free solder encapsulating the thin nickel layer further comprises diffused gold.

27. A solder joint according to claim 24 wherein the lead-free solder encapsulating the thin nickel layer further comprises diffused palladium.

28. A solder joint according to claim 24 wherein the thin nickel layer comprises nickel having a thickness sufficient to retard the formation of copper-tin intermetallic compound over time.

29. A solder joint according to claim 24 wherein the thin nickel layer comprises nickel having a thickness of less than about 0.28 microns.

30. A solder joint according to claim 24 wherein the thin nickel layer comprises nickel having a thickness of greater than about 0.05 microns.

31. A solder joint according to claim 24 wherein the thin nickel layer comprises nickel having a thickness within a range of between approximately 0.05 microns and approximately 0.28 microns.

32. A solder joint according to claim 24 wherein the intermetallic compound layer further comprises undulations.

33. A solder joint for a semiconductor apparatus assembly, wherein the assembly has at least one copper connection site, the solder joint comprising:
a thin undulating intermetallic compound layer comprising copper-nickel-tin bonded to the copper connection site;
a thin nickel layer bonded to the thin intermetallic compound layer; and
solder encapsulating the thin nickel layer and the thin undulating intermetallic compound layer forming a solder joint, the solder joint further comprising a relatively small quantity of diffused palladium.

34. A method for forming a multilayer solder attachment site in an electronic assembly having one or more copper connection sites, the method comprising the steps of:
applying a thin nickel layer to at least one copper connection site;
applying a diffusion layer to the thin nickel layer;
thereby forming a multilayer solder attachment site for facilitating the formation of an intermetallic compound upon the application of molten solder.

35. A method according to claim 34 wherein the intermetallic compound comprises copper-tin.

36. A method according to claim 34 wherein the intermetallic compound comprises copper-tin-nickel.

37. A method according to claim 34 wherein the diffusion layer comprises palladium.

38. A method according to claim 34 wherein the diffusion layer comprises gold.

39. A method according to claim 34 wherein the thin nickel layer is applied to a thickness of greater than about 0.05 microns.

40. A method according to claim 34 wherein the thin nickel layer is applied to a thickness of less than about 0.28 microns.

41. A method according to claim 34 wherein the thin nickel layer is applied to a thickness within the range of approximately 0.05 microns to approximately 0.28 microns.

42. A method according to claim 34 wherein the diffusion layer is applied to a thickness of greater than about 0.1 microns.

43. A method according to claim 34 wherein the diffusion layer is applied to a thickness of less than about 0.3 microns.

44. A method according to claim 34 wherein the diffusion layer is applied to a thickness within the range of approximately 0.1 microns to approximately 0.3 microns.

45. A method according to claim 34 further comprising steps of interposing an intermediate nickel layer atop the copper connection site and an intermediate copper layer thereon underlying the thin nickel layer.

46. A multilayer solder attachment site in an electronic assembly having one or more copper connection sites, the multilayer solder attachment site comprising:
a thin nickel layer on at least one copper connection site;
a diffusion layer on the thin nickel layer;
wherein a multilayer solder attachment site is provided for facilitating the formation of an intermetallic compound upon the application of molten solder.

47. A multilayer solder attachment site according to claim 46 wherein the multilayer solder attachment site is adapted for the formation of an intermetallic compound comprising copper-tin.

48. A multilayer solder attachment site according to claim 46 wherein the multilayer solder attachment site is adapted for the formation of an intermetallic compound comprising copper-tin-nickel.

49. A multilayer solder attachment site according to claim 46 wherein the diffusion layer comprises palladium.

50. A multilayer solder attachment site according to claim 46 wherein the diffusion layer comprises gold.

51. A multilayer solder attachment site according to claim 46 wherein the thin nickel layer is greater than about 0.05 microns in thickness.

52. A multilayer solder attachment site according to claim 46 wherein the thin nickel layer is less than about 0.28 microns in thickness.

53. A multilayer solder attachment site according to claim 46 wherein the thin nickel layer is within the range of approximately 0.05 microns to approximately 0.28 microns in thickness.

54. A multilayer solder attachment site according to claim 46 wherein the diffusion layer is greater than about 0.1 microns in thickness.

55. A multilayer solder attachment site according to claim 46 wherein the diffusion layer is less than about 0.3 microns in thickness.

56. A multilayer solder attachment site according to claim 46 wherein the diffusion layer is within the range of approximately 0.1 microns to approximately 0.3 microns in thickness.

57. A multilayer solder attachment site according to claim 46 further comprising an intermediate nickel layer atop the copper connection site and an intermediate copper layer thereon underlying the thin nickel layer.

58. A multilayer solder attachment site according to claim 57 wherein the intermediate nickel layer is approximately 0.5 microns in thickness.

59. A multilayer solder attachment site according to claim 57 wherein the intermediate copper layer is greater than about 0.5 microns in thickness.

60. A multilayer solder attachment site according to claim 57 wherein the intermediate copper layer is less than about 1.0 microns in thickness.
